(19) United States
(12) Patent Application Publication
(10) Pub. No.: US 2017/0076314 A1
(43) Pub. Date: Mar. 16, 2017

(54) MULTI-PLATFORM DATA GATHERING AND REWARDS ADMINISTRATION FOR AUTOMATED LIBRARY SYSTEMS

(71) Applicant: Central Technology, Inc., Avon, IN (US)

(72) Inventors: Kenneth Czapla, Plainfield, IN (US); Mitchell Czapla, Indianapolis, IN (US)

(73) Assignee: Central Technology, Inc., Avon, IN (US)

(21) Appl. No.: 15/124,956

(22) PCT Filed: Mar. 11, 2015
(86) PCT No.: PCT/US2015/020018

§ 371 Date: Sep. 9, 2016

Related U.S. Application Data
(60) Provisional application No. 61/951,093, filed on Mar. 11, 2014.

(51) Int. Cl. G06Q 30/02; G06Q 30/06

(52) U.S. Cl. CPC G06Q 30/0226; G06Q 30/0645

(57) ABSTRACT

Processing a checkout transaction at a library includes scanning a patron identifier and an item identifier at a computerized checkout station, and reading stored data associated with the item identifier which is indicative of at least one of a classification parameter, a content parameter, and a size parameter, of the item of media. The process further includes determining a rewards value for the item of media, and increasing a total rewards score in a database record associated with the patron identifier on a remote computing system.

### TECHNICAL FIELD

The present disclosure relates generally to a computer implemented library rewards strategy and computerized system, and more particularly to determining a rewards value for an item of media in a library collection in a manner transparent to library patrons and personnel, and responsively updating a rewards score stored at an offsite server.

### BACKGROUND

Like many municipal institutions, libraries face challenges in the current economic environment, such as increased operating cost, increased competition and declining revenues. These conditions are forcing many libraries to rethink their current business models, and to devise state-of-the-art promotional campaigns in order to compete with private entities in an effort to promote their services to the public. One type of proposed solution is for a library to open their doors to corporate sponsorship, in exchange for branding rights on a poster, or a mention in a newsletter, for example. Such proposals have found limited library participation due to a low return-on-investment for the sponsoring company and, moreover, difficulties that a library may face in regards to tax regulations and implications for the library's own rules and policies.

For example, each potential corporate sponsor or sponsorship may be required to follow strict guidelines such that their product or service meets minimum qualifications respecting equity of access to library services, and not giving unfair advantage to, or causing discrimination against sectors of the community. The potential corporate sponsor or sponsorship must at least theoretically also protect principles of intellectual freedom. Sponsors are also typically prohibited from influencing staff advice, or engaging in any activity deemed unethical by the library's standards.

Private companies have made various attempts to resolve the challenges libraries face, and have offered various solutions to bring sponsorship into the library. One known strategy is entitled, “Anonymity-ensured system for providing affinity-based deliverables to library patrons” and set forth in U.S. Pat. Nos. 8,407,062 and 7,890,337. In these patents, a strategy is proposed that allows a library user to be rewarded for checking out materials based on their reading interests. What is also presented to the user within the library premises is advertising content, displayed on the monitor of the library's self-checkout station, or automatically printed to a dedicated ad/coupon printer.

The above strategy requires a major investment of time and staff labor in order to create the required category number for each individual bar-coded item in a database server used to discover the user's reading interests. It also requires a large capital investment for upgraded infrastructure, including a dedicated web server, database server and coupon printers, and may result in commercial intrusion considered by library staff, administrators, and users to be in conflict with the library's core mission.

### SUMMARY

Processing a checkout transaction in a library includes scanning a patron identifier for a library patron via a scanner of a computerized checkout station in the library, and scanning an item identifier stored on an item of media to be checked out by the library patron via a scanner of the computerized checkout station. Stored data associated with the item identifier is read to indicate at least one of a classification parameter, a content parameter, and a size parameter, of the item of media. A rewards value for the item of media is based on the stored data, and used to increase a total rewards score in a database record associated with the patron identifier and stored on a remote computing system.

### BRIEF DESCRIPTION OF THE DRAWINGS

FIG. 1 is a system level diagram of a system, according to one embodiment;

FIG. 2 is a flowchart illustrating control logic flow according to one embodiment;

FIG. 3a is an example screen shot of a user interface in the computing system of FIG. 1;

FIG. 3b is another example screen shot of a user interface;

FIGS. 4a-d are pictorial illustrations and concept diagrams of activities performed in connection with providing and redeeming rewards according to the present disclosure;

FIG. 5 is a block diagram illustrating control logic component pieces, according to one embodiment; and

FIG. 6 is another flowchart illustrating control logic flow according to one embodiment.

### DETAILED DESCRIPTION

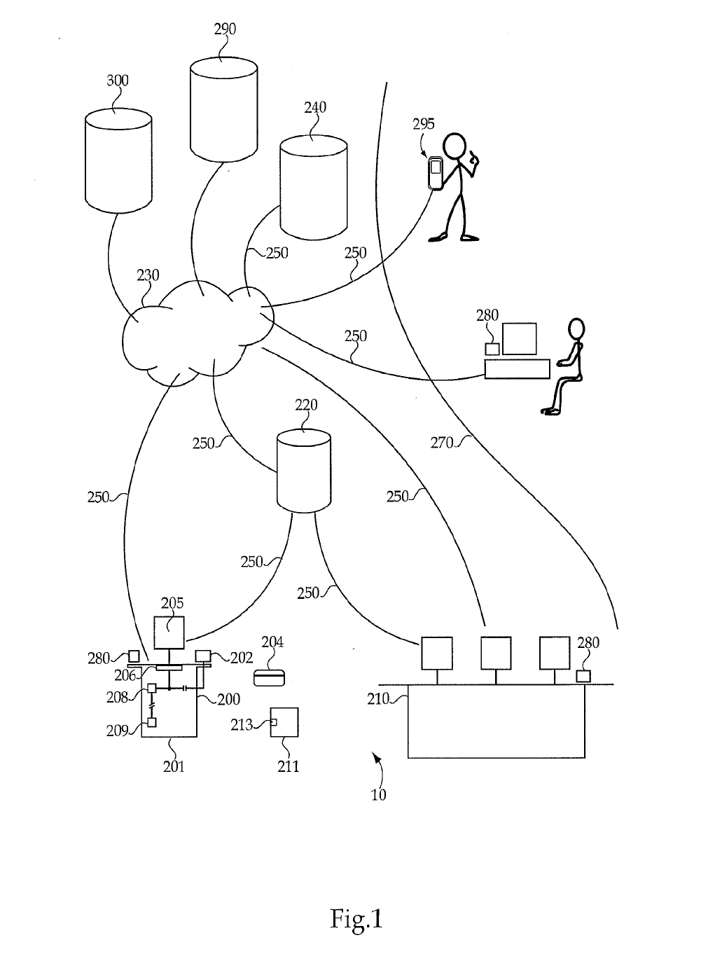

Referring to FIG. 1, there is shown a computerized system 10 for processing a checkout transaction at a library, and awarding and tracking rewards to a library patron for checking out items of media. System 10 may include a computerized checkout station 200, which may be a self-check station as are well-known in the art. Station 200 may include a housing 201 having mounted thereon a computer display terminal 205 in communication with a data processor 208. Processor 208 may be in communication with a computer readable memory or medium 209 resident in housing 201, or located elsewhere. Memory 209 could also be located at a hosted server, for instance. Processor 208 may be any suitable microprocessor configured by way of appropriate inputs and outputs to communicate with peripheral devices, with other computers and display 205, and to read and execute stored computer code on memory 209 for processing checkout transactions at station 200 and performing the other functions described herein. Processor 208 may also be configured to determine a rewards value by way of performing calculations, reading stored tables, or formulating database queries, as further discussed herein, and for communication with wireless and/or wired communications networks. In other practical implementation strategies, rewards value determination will occur on another computer, and typically a computer that is part of a computer system remote from system 10. As will be further apparent from the following description, system 10 is uniquely configured to award and track rewards to library patrons, for instance in the form of points, for checking out items of media in a manner that will be transparent to patrons and to the library institution and requires no direct participation, support or commercial sponsorship or intrusion.

As also discussed herein, system 10 may be configured to be applied across checkout platforms. Those skilled in the art will be familiar with the diversity of product suppliers and service providers in connection with library checkout systems and library database administration. The present disclosure contemplates a rewards program that can be implemented without reconfiguring or replacing the various different computer hardware and processes applied throughout the industry. The present disclosure, moreover, provides an architecture and distribution of computing functions such that updating and upgrading, including changes to the manner of rewards calculation, is simple and efficient. For instance, as further discussed herein by performing rewards value calculations on one server remote from the library but in communication with many checkout stations, patron data and checked out item data gathered at a large number of individual checkout stations can be processed at a singled, centralized location, enabling substantive changes in the rewards administration scheme to be implemented on only one computer.

Station 200 may further include one or more scanners configured to scan a patron identifier, and an item identifier stored on an item of media to be checked out by a library patron. In a practical implementation strategy, station 200 includes a first scanner in the nature of a magnetic card reader 202 that can read a magnetic stripe encoding the patron identifier on a conventional library card 204. Reader 202 might instead be a radiofrequency scanner that reads a patron identifier in the manner of so called RF tags. Station 200 may also include another scanner 206 of any suitable type. Scanner 206 may be configured for scanning the item identifier stored in a computer or machine-readable format in a medium 213 on an item of media 211 such as a book, dvd, cd, magazine, newspaper, or any other item of media in a library collection. Station 200 could also include a laser scanner for scanning bar codes on labels, as are commonly used for labeling most media types in a library collection. The present disclosure is expected to find application regardless of the medium or form on which machine or computer readable patron identifiers and item identifiers are stored.

For purposes of the present description, processor 208 may be understood as a computer in communication with and receiving inputs from the one or more scanners 202 and 206, and in communication with or capable of communication with all the other components of system 10. The terms processor and computer are used interchangeably herein. Computer 208 may be configured to receive inputs from the one or more scanners indicative of the patron identifier and the item identifier. Computer 208 may also be configured to authorize release of an item of media to a library patron, in a generally conventional manner. Computer 208 may further be configured to read and receive data stored on a computer readable medium that is associated with the scanned item identifier or with an alternative item identifier and indicative of at least one of a classification parameter, a content parameter, and a size parameter, of the item of media. The computer readable medium storing the subject data may be part of a server 220 suitably configured as a conventional library database (ILS) server, for instance. Computer 208 could be understood to receive the data by reading the stored data from the server, or by way of receiving communications encoding the data of interest as further discussed herein.

Those skilled in the art will thus appreciate that server 220 may include a database storing data indicative of classification, content, and size for each item in a collection of media held by the library. Computer 208 may in the course of a checkout transaction communicate with server 220 to determine such factors as whether a patron is permitted to check out items from the library, for example whether the patron is blocked, whether certain items sought to be checked out are restricted to a minimum age of the patron, whether the patron needs to pay overdue fees to be authorized to check out items, and to perform a variety of other functions associated with item and patron tracking.

In other instances, server 220 may not store the data of interest, or the data of interest may not be readily accessible to any of the computers of checkout stations in the library. This could be due to limited access privileges, for instance. It also may be undesirable or technically challenging to obtain the data of interest via communicating with the ILS server by way of the obligatory Standard Interchange Protocol (SIP2) that is used in virtually all library computer systems. Variations in product and service among different checkout station manufacturers and service providers result in uncertainty as to the capabilities of any particular library computing system. Accordingly, in certain systems the data of interest might be readily accessible by communicating with the ILS server. In other systems, the data of interest might not be available at all, and in still others such access might be theoretically accessible but access clumsy or inordinately difficult. In any event, as will be further apparent from the following description the present disclosure contemplates alternative mechanisms for obtaining the data of interest, namely, data indicative of classification, content, and/or size for an article of media to be checked out, such that the peculiarities of any particular system cease to matter.

Computer 208 may be further configured to determine a rewards value for an item of media to be checked out, responsive to the stored data. Computer 208 may be further configured to output an electronic record encoding the determined rewards value so as to increase a total rewards score, responsive to the determined rewards value, in a database record associated with the library patron. It will be recalled that server 220 stores a database associated with items of media in the library collection. Elsewhere, another server 240, referred to hereinafter as a marketplace server and remote from or external to the library, can store a database with a plurality of records each associated with the patron identifiers for any or all of the patrons having accounts with the library. The database records on server 240 may each include a total rewards score which is increased as additional rewards are accrued, or decreased as rewards are redeemed in a manner further discussed herein. In some embodiments, a patron may opt out of participating in the rewards program, but the rewards can still be tracked in the remote database in the case the patron changes his or her mind and decides to later opt in to the rewards program. A plurality of communication paths 250 are also shown in FIG. 1, and represent actual and theoretical electronic communication paths by way of wireless or wired transmissions between and among the various components of system 10. An external communications network 230, which may be or include or be a part of the Internet, is also shown in FIG. 1. A plurality of patrons at 270 are shown in communication via communication paths 250 and network 230 with server 240, and also potentially with computers at the library, whereby the patrons can access their database accounts on server 240 to monitor their rewards points and take steps to redeem the same.

In an alternative strategy, determination of the rewards value occurs via a computer that is part of or in proximity to server 240. Server computer 240 can be configured to perform the same operations respecting rewards administration as computer 208, and thus the description of computer 208 respecting rewards administration should be understood to similarly apply to server 240. Thus, the functions of computer 208 may be to execute checkout transactions for articles of media to be checked out, and also to perform the data gathering and related functions that are used in determining the rewards value, as further discussed herein, but not to perform the rewards calculation itself. Computer 208 may be understood to execute a checkout session and also a rewards session. As further discussed herein, the checkout session software and the rewards session software are typically separate routines that run in parallel. The two routines or types of sessions may be invoked or called in response to satisfaction of the same criterion, but ended in response to different satisfaction of different criteria. These and other features enable the presently disclosed rewards administration to be implemented without modifying or integrating with existing checkout platforms on diverse checkout stations. Server 240 meanwhile performs the rewards value calculations and rewards database management, and can be updated or upgraded or serviced without disturbing the operation of checkout stations at all.

Also shown in FIG. 1 is a staffed station 210 where library staff might assist patrons in checking out, rather than by the patrons using self-checkout procedures such as at station 200. Staffed station 210 may include one or more computers having all the same capability, software and hardware as station 200. At each of the checkout stations in the library is located a receipt printer 280 that can print a receipt listing the details of a checkout transaction executed on behalf of a patron, and print a receipt listing the rewards points assigned to a particular transaction and/or particular item, as well as potentially listing the total rewards points associated with a patron's account and stored in the database on server 240. Receipt printer(s) 280 can be understood herein as a peripheral device in communication with one or more checkout station 200. Patrons might also use a personal printer for printing such receipts and potentially coupons or discount cards as desired, or a separate printer independent of the printers used to print checkout receipts might be used.

It will be recalled that library server database 220, or another database with which computer 208 may communicate, may store data indicative of at least one of a classification parameter, a content parameter, and a size parameter, for a collection of items of media held by the library. As used herein, the term database should be understood to include conventional server databases as well as cloud storage or any other type of retrievable or searchable collection of electronically and/or magnetically stored information. Computer 208, or a computer associated with marketplace server 240 for instance, may be configured to calculate a plurality of different rewards values based on a plurality of possible combinations of classification, content, and size parameters as determined by the data for the collection of items of media. Those skilled in the art will appreciate that apart from multiple copies all of the items of media in a library collection are different, and may number in the hundreds of thousands or potentially millions. Rewards assigned to a patron for checking out any given one of the items of media in the collection can vary based on the nature of the item. Systems are contemplated where a patron is assigned one rewards point for a fiction book under fifty pages. For a fiction book equal to or over fifty pages but less than 100 pages the patron might be assigned five points. If the book is a non-fiction book, however, the patron might be assigned two points where under fifty pages and ten points where equal to or over fifty pages but less than 100 pages. For books equal to or over 100 pages, ten points might be assigned for fiction and twenty points assigned for non-fiction. The points assigned could further be increased for books still greater in length. For other sorts of items, such as dvd's or cd's, one point might be assigned for fiction and two points assigned for non-fiction or documentaries. Video games, newspapers, magazines and audio books could all have different point values based upon classification, content or size.

As used herein, the term classification refers to the type of media, such as book, dvd, video game, audiobook, magazine, etc. Content refers to the subject matter of the media irrespective of media type, such as fiction versus non-fiction. Content could also be quite extensive, including groupings such as young adult fiction, children's books, adult fiction, biography, reference, and others consistent with standard schemes used in modem libraries. For instance, embodiments are contemplated where points could be assigned based upon whether a children's book includes content about horses, science fiction, or early world exploration. The size parameter will typically mean page number, in the case of books, or duration in the case of audio books, dvd's, etc. In most embodiments, rewards value will be determined on the basis of multiple factors, in other words the relative value of any item of media will not be determined as either a 0 or a 1. Another way to understand this principle is that a rewards value of any given item will typically depend upon at least two of the parameters of classification, content, and size, and commonly all three parameters. Embodiments are also contemplated where rewards value could vary based upon a patron's history with the library. For instance, one point might be awarded for each dvd up to a total of 10, after which no more credit is given in a single calendar year. Another way to understand this principle is that the rewards values could be determined on the basis of sliding scales.

In a practical implementation strategy, awarding of points could also be limited to a plurality of possible combinations including a finite number of about one hundred or less. In other words, while there are numerous different parameters that could be combined in a number of different ways, a reward points weight scale could be based on a combination of item classification, content, and size, so that no more than one hundred different point values exist. Far fewer potential point values might also be used, such as only five or six. This might mean that any given item in the library could be worth from, say, one to five points.

Also shown in FIG. 1 are additional, third party external servers 290 and 300, which might be part of computer systems familiar to those in the library environment such as google books, OCLC or good reads, or still others. It will be recalled that retrieval of data used in determining a rewards value, in particular the data indicative of classification parameter, content parameter, or size parameter, may not be readily available from on-site library (ILS) databases. For this reason, in connection with the present disclosure development of a practical way to obtain such data in an automated library environment required an alternative. To this end, it was discovered that queries could be run on servers remote from the library's resident computer system, and a great many different properties and characteristics of an item of media pulled into the library's computer system, and either processed by the resident checkout stations or transmitted on to another remote computer system such as server 240.

Institutional data collections, such as that of the servers 290 or 300, typically provide certain rules and/or guidelines specifying the manner in which their content is to be accessed and searched. The rules and/or guidelines are generally made available in the form of or in connection with an Application Programming Interface (API). Those skilled in the art will be familiar with the International Standard Book Number (ISBN) that is associated with many if not most items of media in library collections. One of the parameters specified by way of the associated API in connection with accessing and searching information on certain server collections of data is the ISBN. To obtain any data at all in some instances, and in others to obtain data sufficient in diversity and reliability to provide a rich and meaningful set or continuum of rewards, obtaining the ISBN for items of media to be checked out was discovered to be necessary. It was further observed that the ISBN is a piece of information specific to a particular title of an item of media that can be retrieved from certain servers commonly maintained at libraries, in particular the so-called library web services server or in some instances the ILS server.

As discussed above, most libraries maintain an internal or external and hosted ILS server and all of the computers at a given library, or potentially at multiple libraries in a city or county library system, communicate with the ILS server by way of the well-known SIP2 protocol. The libraries' web services servers, on the other hand, are typically accessed and communicated with according to a different protocol, typically http. For this reason, the unwieldy or forbidden, and commonly slow, communication with an ILS database in an attempt to obtain an ISBN or for that matter any information can be dispensed with. In connection with rewards determination and rewards score logging, the library computer system may be used only for obtaining the information that is used in a rewards value calculation, and the actual calculation performed remotely such as on server 240.

In a practical implementation strategy, computer 208 may read from the web services server an ISBN for an item of media to be checked out. Determining the ISBN may take place by retrieving the item title using a scanned barcode, and then matching the captured item title with an ISBN. Several calls from computer 208 to the webserver may be necessary, for instance, at least a first call to retrieve the item title, and at least a second call to retrieve the ISBN. Stated another way, computer 208 may invoke a function on the web services or ILS server multiple times before the desired information is captured. Using that ISBN, computer 208 can invoke a function on server 290 or 300 to obtain the information pertinent to rewards value determination. The function invoked may execute so as to return the data desired, and in particular may return a value for at least one of a classification parameter, a content parameter, and a size parameter of the item of media.

By way of example, once a patron is authenticated they might scan the book Moby Dick so that the barcode or other item identifier is read. Computer 208 would then proceed to communicate with the library web services or ILS server to retrieve the ISBN or other alternative identifier. With that identifier now known, computer 208 can communicate with server 290 or 300 to retrieve data such as type of media, page number, fiction versus non-fiction, and still other pieces of information. In each iteration of data retrieval from server 290 or 300, or still another server, computer 208 could be expected to obtain a value indicative of the parameter of interest, store that value in computer memory at least temporarily, and then encode that value in a transmission from the checkout station to server 240 for use in calculation of the rewards value, and the increase in the stored total rewards score in a database record for the patron. While the above described procedure may appear relatively complex so as to retrieve a relatively simple piece of information such as page number, it should be appreciated that the richer the information that can be retrieved about a given item of media, the more sophisticated and ultimately fair the associated rewards program can be.

As also discussed above, computer 208 may perform certain monitoring functions during a checkout transaction so that determination of the rewards can successfully occur, and in a manner transparent to the patron and transparent to library personnel. In a practical implementation strategy, rewards software running on computer 208 in parallel with checkout software will detect certain criteria are satisfied and then commence the rewards determination. To this end, computer 208 may be understood to be programmed to execute a monitoring component monitoring data gathered by the one or more scanners, and a managing component processing a subset of the gathered data. Computer 208 may further be configured via the programming such that the monitoring component selectively passes data to the managing component that satisfies a predetermined criterion. The predetermined criterion may be a number string criterion, such as counting of fourteen consecutive digits so as to indicate a conventional barcode. Computer 208 may further be in communication with a receipt printer for the checkout station, and configured via the programming such that the monitoring component selectively passes data to the managing component indicative of a change in status of the receipt printer, to terminate the rewards session, as further discussed herein. Termination of a checkout session may occur by way of a change in state of a first peripheral device, such as a touch screen, whereas termination of the rewards session may occur by way of a change in state of a second peripheral device, such as the receipt printer. Properties of the monitoring component and managing component are further discussed below.

### INDUSTRIAL APPLICABILITY

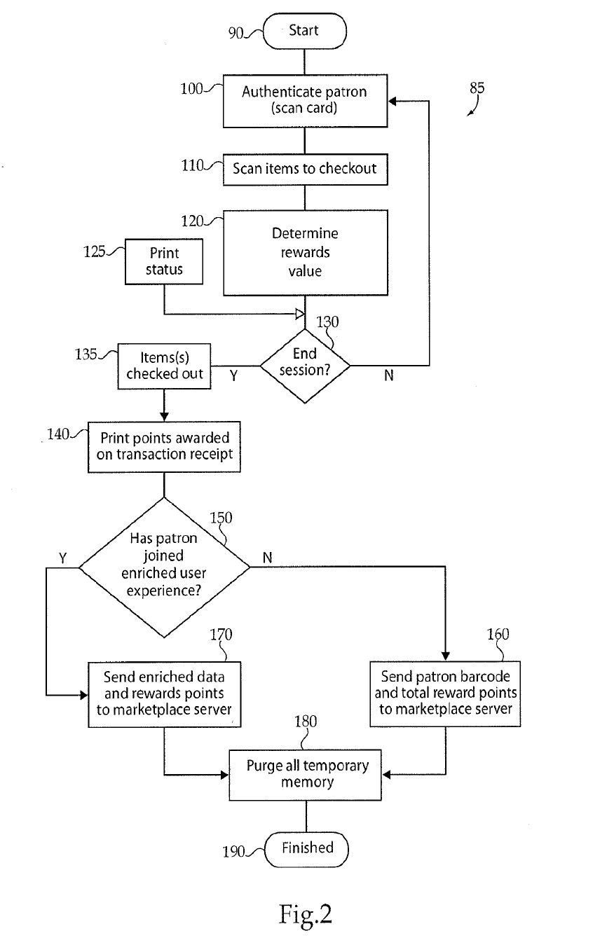

Referring now to FIG. 2, there is shown a flowchart 85 illustrating an example control process according to the present disclosure, and in particular illustrating processing of a checkout transaction at a library. The process of flowchart 85 may start at step 90, and proceed to step 100 where a patron identifier is scanned from a library card, for instance, via a scanner of a computerized checkout station such as station 200 in the library. From step 100, the process may proceed to step 110 to scan an item identifier stored on an item of media to be checked out by the library patron, via a scanner of the computerized checkout station. From step 110, the process may proceed to step 120 to determine a rewards value for one or more items scanned at step 110. Determining the rewards value can include reading stored data associated with the item identifier for each scanned item of media, and being indicative of at least one of a classification parameter, a content parameter, and a size parameter, of the item of media, as discussed herein. It will be recalled that the rewards value determination could be performed by computer 208, or server 240, for example. With the rewards value determined, the rewards value can be stored in memory, such as on memory 209 of station 200. From step 120 the process may proceed to step 130 to query whether the session is to be ended. If no, the process may loop back to scan further items at step 110. If yes, the process may proceed to step 135 where the items are checked out. Checking out items as contemplated herein means updating of the library server database to reflect association of a particular item with a particular patron, logging of a checked out date, a due date, and potentially other factors consistent with conventional library practice. As part of or subsequent to the checkout process, computer 208 may also authorize or execute the unlocking of security devices on items of media to release the item to the library patron. Releasing the item to the patron may include disabling a security mechanism, for example an electronic security device such as an electronic security bit on an RF tag or a mechanical/magnetic security device on the item of media or a case for the item of media, as will be familiar to those skilled in the art.

From step 135, the process may proceed to step 140 where the points awarded, the determined rewards value, is printed on a transaction receipt. From step 140, the process may proceed to step 150 to query whether the patron has joined an enriched user experience. If no, the process may proceed to step 160 where the patron bar code, or other indicator of patron identity, and total rewards points associated with a particular transaction is forwarded to the marketplace server. Check out station 200 might transmit a signal or a series of signals comprising an electronic record encoding the patron identifier and a numerical point value to server 240. For instance, if, at step 150, the patron has joined the enriched user experience, the process may proceed to step 170 to send enriched data and rewards points to marketplace server 240. In the case of an enriched user experience, this may mean that the library patron has opted-in to the rewards program. Additional information such as the patron's email address can be forwarded to server 240. In general terms, the difference between processing at step 170 versus step 160 is that a patron may opt-in or not opt-in to the enriched user experience where rewards points are tracked for purposes of enabling patrons to later redeem those reward points. In the case of not opting-in, points may simply be tracked in association with a particular patron identifier so that should the patron later decide to opt-in to the program their accrued rewards points could still be made available. When the patron has opted in, step 170 will prepare the record in the database at server 240 for accessing and exploitation by the patron. From either of steps 160 or 170, the process may proceed to step 180 to purge all temporary memory, meaning all data associated with the transaction and stored on memory 209, and then may finish at step 190.

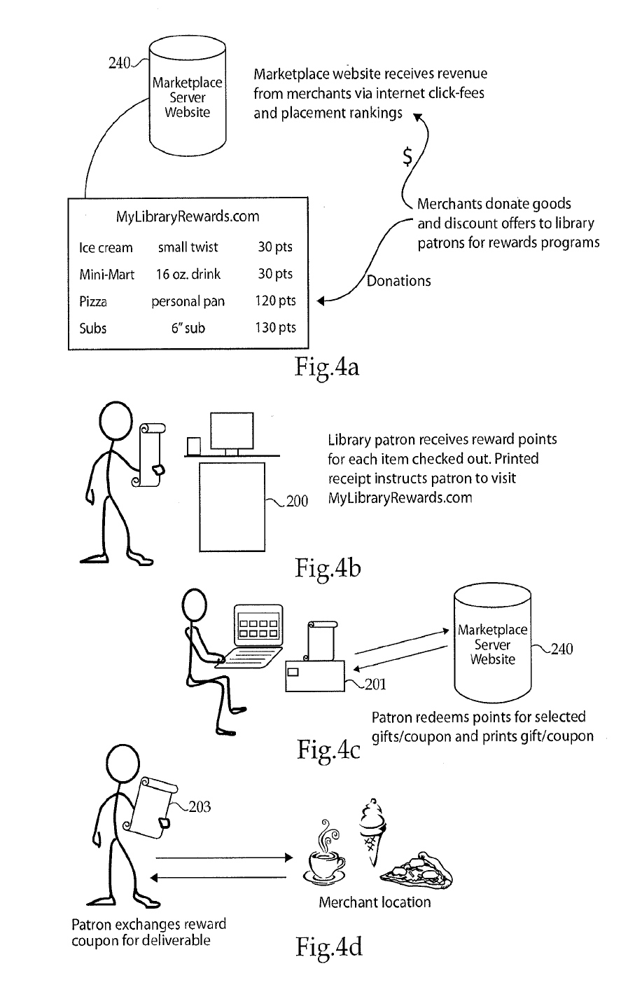

Referring now to FIG. 4a, there is shown an illustration of redeemable rewards and points acquired as might be presented to a user logging in to their account on the marketplace server website. As illustrated in FIG. 4a, merchants may donate goods and discount offers to library patrons for a rewards program of the library. The marketplace server website might receive revenue from merchants via Internet click fees and placement rankings, for instance. In FIG. 4b, there is illustrated a library patron receiving reward points for each item checked out, viewing a printed receipt that instructs the patron to visit a URL such as www.mylibraryrewards.com. In FIG. 4c, a patron is illustrated interacting with the marketplace server website to redeem points for selected gifts, or coupon offers for instance, and printing out gift or coupon offer rewards. FIG. 4d illustrates the patron exchanging a reward coupon for deliverables at a merchant's location. From FIGS. 4a-d, it can be seen that the present system and methodology is contemplated to support the development of a rewards ecosystem based on the participation of library patrons, one or more marketplace servers and sponsoring entities and libraries.

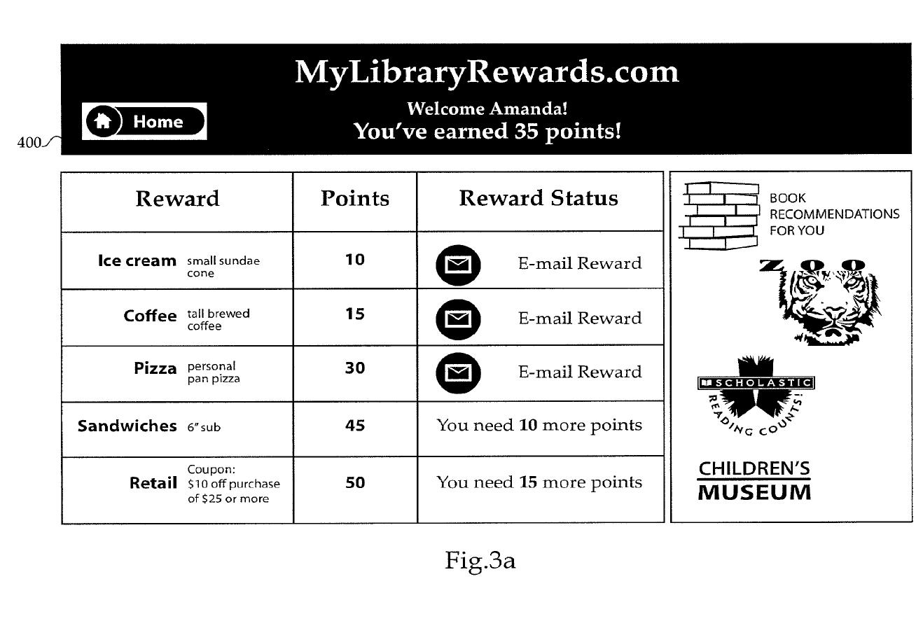

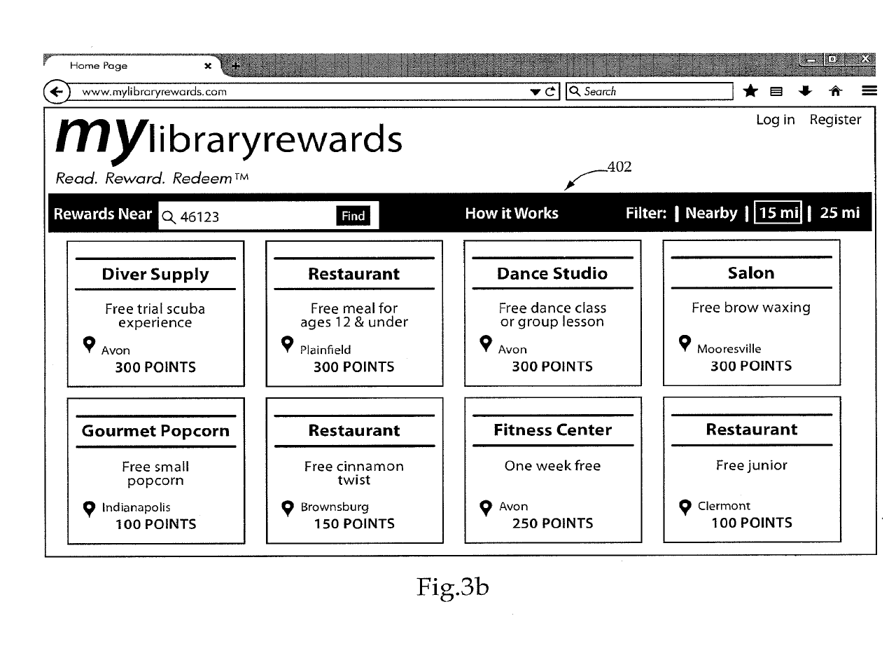

Referring now to FIGS. 3a and 3b, there are shown displays 400 and 402 which might be presented to a patron on a graphical user interface of their computer, including an electronic handheld device computer, illustrating different rewards available from different participating entities, the points required to redeem those rewards, and clickable options for emailing those rewards to the patron such as in the form of a coupon that can be printed or displayed on a personal handheld electronic device for redemption. Also shown in the display 400 next to certain of the listed rewards is an indication of a number of points still needed to enable a patron to obtain those rewards.

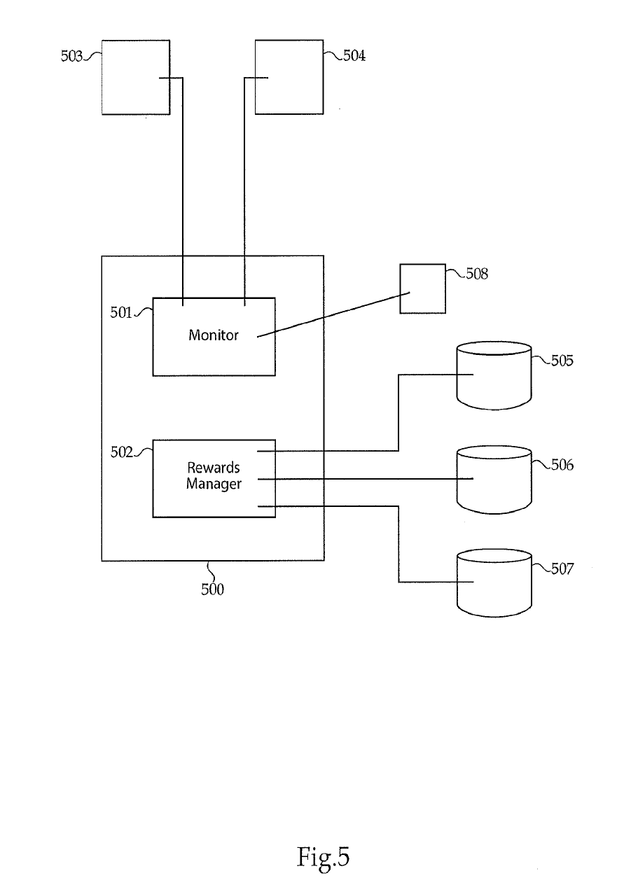

Referring to FIG. 5, there is shown a block diagram including a processor block 500, a block 501 corresponding to the monitoring component, and in communication with blocks 503, 504, and 508, representing a circulation workstation keyboard, a receipt printer, and input/peripheral devices respectively, and a block 502 corresponding to the management component. The management component 502 is in communication with servers 505, 506, and 507, corresponding respectively to an internal library web services server and/or ILS server, a remote and external third party server storing data to be used in determining a rewards value, and a remote marketplace server, as described herein. As noted above, a computer at a checkout station such as computer 208 may be programmed to execute a monitoring component, monitoring the data gathered by the one or more scanners or other peripheral devices, and a managing component, processing a subset of the gathered data and communicating with the various internal and external servers. In a practical implementation strategy, monitoring component 501 is receiving data gathered via the scanners or other peripheral devices, and selectively passes data to managing component 502 so that rewards can be effectively determined and processed. Monitoring component 501 may also communicate with keyboard 503 so as to monitor a function key, such as F7, enabling staff to manually end a rewards session, and also monitoring status of receipt printer 508.

Monitoring component 501 may thus be thought of as the gatekeeper that observes the data entered on the checkout station, but only passes the data to monitoring component 501 that is relevant to rewards processing. In particular, monitoring component 501 intercepts patron ID's, item ID's that have been scanned via input devices on the associated checkout station, and passes such information to managing component 502. Monitoring component 501 also notifies managing component 502 when a change in receipt printer status occurs, such as when the receipt printer 508 is printing.

Managing component 502 may be thought of as the router that passes information to and receives information from the various servers. In particular, managing component 502 processes the data that is received from monitoring component 502, such as via formatting that data into communication strings, and sends those strings off to the various internal and external database servers in the effort to determine point value of an item checked out and to retrieve other item data such as item's page count, item type, ISBN, web-link to the book jacket graphic, and communicate as needed with the marketplace server. Additionally, barcode data is received from the monitoring component 501 to determine the start of a checkout session, which is when a patron card is scanned, by detecting a known barcode prefix such as a fourteen digit number string beginning with “2”. The checkout session and rewards session may each be invoked via the detection of the known barcode prefix. The checkout session ends when the patron enters a reply to an end session prompt on a patron input or peripheral device, such as a touchscreen, and the rewards session ends when the printer prints a receipt for the items checked out. In other words, the checkout session may end in response to the patron's action, and the rewards session ends upon detection of the consequence of the ending of the checkout session, i.e. the printing of the checkout receipt. In one embodiment, the rewards session will not end unless at least one item of media has been scanned. Upon the end of a rewards session, points are totaled up in the patron's database record, and a separate receipt may be printed showing the patron's total rewards points, an email or text message sent to the patron, or some other action taken.

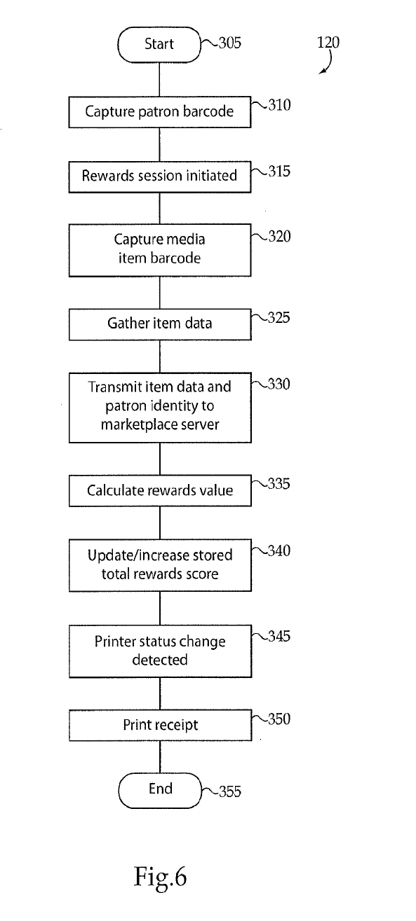

Referring now to FIG. 6, there is shown a flowchart 120 illustrating example control logic in connection with determining a rewards value and updating a database record of total rewards score for a patron. Initialization or START occurs at block 305. From block 305 the logic advances to block 310 to capture the patron barcode, and then to block 315 to initiate the rewards session. From block 315 the logic advances to block 320 to capture the media item barcode. From block 320 the logic advances to block 325 to gather item data, including values for the classification, type and/or size parameters. From block 325 the logic advances to block 330 to transmit the item data and patron identity to the marketplace server. From block 330 the logic advances to block 335 to calculate the rewards value, and then to block 340 to update, typically increase, the stored total rewards score. From block 340 the logic advances to block 345 to detect a change in the printer status, and then to block 350 to print a receipt and end the session at block 355.

As discussed above, there are numerous different ILS service providers, and different levels and type of service are available. In many instances checkout stations, and notably self-check stations, run software that is specific and proprietary to a given company. This may be due to differing hardware or procedural considerations, as ILS service providers may also manufacture the self-check stations, or because certain providers offer different features and functionality in an attempt to distinguish their products and services. Different libraries may also simply obtain different levels of service. Whatever the reason, multiple checkout software platforms are commercially available, each with its own distinct advantages and disadvantages. Any large scale redesign of the manner in which patron and item checkout activity is performed or monitored would thus require participation or at least cooperation with or among the different vendors, and likely a redesign of operating software, if any common goal was to be achieved. Such concerted action or assent is all but impossible to obtain, and for this and other reasons the success of prior attempts at integrating a library rewards program into existing platforms has been limited.

It will also be well understood by those skilled in the art that libraries are increasingly automated, and tasks which were for many years performed by humans are now performed by machines such as computers, scanners, and automated security mechanisms. Moreover, the data of interest discussed herein, namely, the data specific to different items or item types of media is obscured behind a veil of technology. Even access to electronically stored data relating to relatively mundane features such as page number can be difficult to establish, for reasons discussed herein. Complicating matters still further, most libraries operate according to dedicated communication protocol, namely, SIP2, that furthers narrows the field of available solutions to any conceivable technical problem. These factors of a highly automated library environment and diverse library automation platforms, coupled with the unique policy and public interest concerns of libraries combine to make any typical advance in library technology incremental at best. The present disclosure avoids the technical problems presented by multiple platforms by offering a solution that is platform-independent. Rather than integrating data gathering for rewards with the checkout process, the presently disclosed techniques run covertly in parallel with the checkout procedures, and enables the library computer system to look outside the immediate library environment to gather the information useful in calculating rewards scores.

The present description is for illustrative purposes only, and should not be construed to narrow the breadth of the present disclosure in any way. Thus, those skilled in the art will appreciate the various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of processing a checkout transaction at a library comprising the steps of:
scanning a patron identifier for a library patron via a scanner of a computerized checkout station in the library;
scanning an item identifier stored on an item of media to be checked out by the library patron via a scanner of the computerized checkout station;
reading stored data associated with the item identifier and being indicative of at least one of a classification parameter, a content parameter, and a size parameter, of the item of media;
determining a rewards value for the item of media responsive to the stored data;
authorizing checking out the item of media by the library patron; and
increasing a stored total rewards score responsive to the rewards value for the item of media once checked out, in a database record associated with the patron identifier and stored on a remote computing system.

2. The method of claim 1 further comprising a step of transmitting an electronic record encoding the stored data from the checkout station to the remote computing system over a communications network.

3. The method of claim 2 wherein the electronic record encodes the patron identifier.

4. The method of claim 2 wherein the step of reading includes electronically reading a stored record in a server database remote from the library.

5. The method of claim 1 wherein the step of determining further includes a step of calculating the rewards value based upon each of a stored page number count corresponding to the size parameter and a stored media type corresponding to the classification parameter, for the item of media.

6. The method of claim 5 further comprising a step of calculating a different rewards value for a different item of media having the same classification parameter and a different page number count.

7. A system for determining rewards to a library patron in a checkout transaction comprising:
a checkout station having one or more scanners configured to scan a patron identifier for a library patron and an item identifier stored on an item of media to be checked out by the library patron;
a computer in communication with the checkout station and being configured to receive data gathered by the one or more scanners and being indicative of an identity of the patron and data indicative of an identity of the item of media;
the computer being further configured to receive parameter data indicative of at least one of a classification parameter, a content parameter, and a size parameter, of the item of media; and
the computer being further configured to determine a rewards value for the item of media responsive to the parameter data, and to update a database record for the patron on a remote computing system so as to increase a stored total rewards score in the database record responsive to the determined rewards value.

8. The system of claim 7 wherein the computer includes a remote computer in communication with the checkout station by way of a communications network.

9. The system of claim 8 wherein the checkout station includes a second computer in communication with the one or more scanners, and the second computer being programmed to execute a monitoring component monitoring the data gathered by the one or more scanners, and a managing component processing a subset of the gathered data.

10. The system of claim 9 wherein the second computer is further configured via the programming to execute an item checkout component in parallel with the monitoring component and the managing component.

11. The system of claim 9 wherein the second computer is further configured via the programming such that the monitoring component selectively passes data to the managing component that satisfies a predetermined criterion.

12. The system of claim 11 wherein the predetermined criterion includes a number string criterion.

13. The system of claim 11 wherein the second computer is further in communication with a receipt printer for the checkout station, and is configured via the programming such that the monitoring component selectively passes data to the managing component indicative of a change in status of the receipt printer.

14. The system of claim 7 wherein the computer is further configured to calculate a plurality of different rewards values based on a plurality of possible combinations of classification, content, and size parameters as determined by the data for the collection of items of media.

15. The system of claim 10 wherein the plurality of possible combinations includes a finite number of about 100 or less.

16. A method of processing a checkout transaction at a library comprising the steps of:
scanning a patron identifier for a library patron via a scanner of a computerized checkout station in the library;
scanning an item identifier stored on an item of media to be checked out by the library patron via a scanner of the computerized checkout station;
reading stored data associated with the item identifier and being indicative of at least one of a classification parameter, a content parameter, and a size parameter, of the item of media;
determining a rewards value for the item of media responsive to the stored data; and
increasing a stored total rewards score responsive to the rewards value for the item of media, in a database record associated with the patron identifier and stored on a remote computing system.

17. A method of administering a rewards program for patrons of a library comprising the steps of:
operating a computerized checkout station in the library so as to gather data indicative of an identity of a library patron using the checkout station and an identity of an item of media to be checked out by the library patron, using at least one scanner and a computer in communication with the scanner and each resident on the checkout station;
determining a value for at least one of, a classification parameter, a content parameter, and a size parameter of the item of media once identified;
storing the determined value, at least temporarily, in computer memory on the checkout station; and
increasing a stored total rewards score, responsive to the determined value, in a database record associated with the patron and stored on a remote computing system in communication with the checkout station.

18. The method of claim 17 wherein the step of operating includes operating the at least one scanner so as to read an identifier stored in a machine readable form on the item of media, and wherein the step of determining further includes determining from stored data on a library server an alternative identifier for the item of media responsive to the identifier read via the at least one scanner.

19. The method of claim 18 wherein the step of determining further includes invoking a function on a remote server using the alternative identifier, and returning the determined value via execution of the function.

20. The method of claim 19 further comprising the steps of encoding the determined value in a transmission from the checkout station to the remote computing system, and calculating a rewards value for increasing the total rewards score responsive to the determined value and on a microprocessor of the remote computing system.

21. The method of claim 20 wherein the step of operating further includes the steps of counting digits in a numerical string input to the checkout station, and starting the determination of the value responsive to counting a predetermined number of digits.

22. The method of claim 21 wherein starting the determination includes starting a rewards session on the computer of the checkout station so as to read a stored alternative identifier for the item of media from a local server at the library, responsive to the counting of the predetermined number of digits.

23. The method of claim 22 further comprising the steps of detecting activating a receipt printer coupled with the checkout station, and ending the rewards session responsive to the detection of activation of the receipt printer.

24. The method of claim 17 wherein the step of operating includes operating the checkout station so as to check out the item of media on a first library server via executing a checkout session, and wherein the determining and the storing steps occur via executing a rewards session running in parallel with the checkout session.

25. A method of processing a checkout transaction at a library comprising the steps of:
scanning a patron identifier for a library patron via a scanner of a computerized checkout station in the library;
invoking a checkout session on a computer of the computerized checkout station, in response to the scanning of the patron identifier;
invoking a rewards session on the computer of the computerized checkout station, in response to the scanning of the patron identifier;
scanning an item identifier stored on an item of media to be checked out by the library patron via a scanner of the computerized checkout station;
executing the checkout session so as to check out the item of media on a library server in communication with the computerized checkout station;
executing the rewards session so as to return data indicative of at least one of a classification parameter, a content parameter, and a size parameter of the item of media, and transmit the data to a remote server in communication with the computerized checkout station, for responsively increasing a total rewards score for the patron stored thereon;
ending the checkout session in response to a change in state of a first peripheral device coupled with the computerized checkout station; and
ending the rewards session in response to a change in state of a second peripheral device coupled with the computerized checkout station.

26. The method of claim 25 wherein the step of invoking the rewards session further includes invoking a monitoring component in response to the scanning of the patron identifier, and invoking a managing component in response to the scanning of the item identifier.

27. The method of claim 26 wherein the step of ending the checkout session further includes ending the checkout session in response to a reply to an end session prompt entered on a patron input device, and the step of ending the rewards session further includes ending the rewards session in response to activation of a receipt printer.

28. The method of claim 26 further including invoking a function via the managing component on a library server so as to capture an alternative identifier for the item of media, and invoking a function on a remote server via the managing component so as to capture the data.

29. The method of claim 26 further including invoking a function via the managing component on a remote server so as to calculate a rewards value for increasing the stored rewards score.
